(19) United States
(12) Patent Application Publication
(10) Pub. No.: US 2011/0175890 A1
(43) Pub. Date: Jul. 21, 2011

(54) LIGHTING DEVICE FOR DISPLAY DEVICE, DISPLAY DEVICE AND TELEVISION RECEIVER

(75) Inventor: Yoshiki Takata, Osaka-shi (JP)

(73) Assignee: SHARP KABUSHIKI KAISHA, Osaka-shi, Osaka (JP)

(21) Appl. No.: 13/121,708

(22) PCT Filed: Jul. 23, 2009
(86) PCT No.: PCT/JP2009/063164

§ 371 Date: Mar. 30, 2011

(30) Foreign Application Priority Data
Oct. 14, 2008 (JP) 2008-265617

(51) Int. Cl. G09G 5/00

(52) U.S. Cl. 345/211

(57) ABSTRACT

A backlight unit 12 for a display device is a lighting device for illuminating a display panel. The backlight unit 12 includes a cold cathode tube 17, an inverter circuit 30a, a voltage measurement circuit 34 and a power-supply control circuit 33. The inverter circuit supplies power to the cold cathode tube 17. The voltage measurement circuit 34 measures a voltage Va applied to the cold cathode tube 17. The power-supply circuit 33 performs power-supply control for shutting off the power supply to the cold cathode tube 17 if the voltage Va measured by the voltage measurement circuit 34 is equal to or lower than a reference voltage Vb.

### TECHNICAL FIELD

The present invention relates to a lighting device for a display device, a display device and a television receiver.

### BACKGROUND ART

A liquid crystal panel used in a display device such as a liquid crystal television receiver does not emit light and thus a backlight unit is required as a separate lighting device. Such a backlight unit is disclosed in Patent Document 1. The backlight unit is arranged behind a liquid crystal panel (on an opposite side from a display surface). The backlight unit includes a metal chassis, a plurality of cold cathode tubes and an inverter circuit. The chassis has an opening in a surface on the liquid crystal panel side. The cold cathode tubes are housed in the chassis. The inverter circuit supplies power to the cold cathode tubes.

Patent Document 1: Japanese Published Patent Application No. 2002-134293

### Problem to be Solved by the Invention

As disclosed in Patent Document 1, the cold cathode tubes do not turn on due to worn electrodes or variations in internal high-pressure gasses, which occur as they are close to the end of their lifetime. Because no load exits for an output of the inverter circuit, an output voltage abnormally increases. As a result, fire hazards and electrical shock hazards caused by touching parts during troubleshooting may be created due to discharges. To reduce such hazards, a failure detector is provided. In Patent Document 1, on/off conditions of the cold cathode tubes are determined based on tube currents. If the tube currents are not present, that is, the cold cathode tubes are not turned on, the inverter is forcibly stopped to prevent an abnormal increase in output voltage. According to the above configuration, the inverter is stopped when the turn-off conditions of the cold cathode tubes are detected, namely, abnormal conditions are detected. However, the output voltage may increase due to worn electrodes or variations in internal high-pressure gasses, which may occur as the cold cathode tubes are close to the end of their lifetime. This may cause hazardous conditions.

### DISCLOSURE OF THE PRESENT INVENTION

The present invention was made in view of the foregoing circumstances. An object of the present invention is to provide a lighting device for a display device including a system for keeping a voltage from increasing at time close to an end of lifetime of the cold cathode tube. Other objects are to provide a display device including such a lighting device and to provide a television receiver including such a display device.

### Problem to be Solved by the Invention

To solve the above problem, a lighting device of the present invention, which is for a display device and configured to illuminate a display panel, includes a cold cathode tube, an inverter circuit, a voltage measurement circuit and a power-supply control circuit. The inverter circuit is configured to supply power to the cold cathode tube. The voltage measurement circuit is configured to measure a voltage of power supplied to the cold cathode tube. The power-supply control circuit is configured to perform power-supply control for shutting off power supply to the cold cathode tube according to the voltage measuring equal to or lower than a reference voltage. The voltage is measured by the voltage measurement circuit.

According to the lighting device for a display device, the voltage applied to the cold cathode tube is measured and the power supply to the cold cathode tube is shut off if the voltage is equal to or lower than the reference voltage. The power supply is shut off before the voltage starts increasing at time close to an end of lifetime of the cold cathode tube.

An internal gas pressure of the cold cathode tube gradually decreases as the cold cathode tube is used. As a result, the voltage applied to the cold cathode tube also gradually decreases. Sputtered materials are gradually deposited near electrodes and areas of the sputtered materials increase. Electrons flow into the sputtered materials and discharges occur between each electrode and the sputtered materials. When the cold cathode tube comes to the end of its lifetime, the glass tube starts melting due to heat and a hole is formed. As a result, the glass tube loses airtightness and the voltage sharply increases. A voltage shortly before the end of the lifetime is calculated in advance based on a result of an endurance test and set as the reference voltage (can be set slightly higher than the calculated voltage based on the result of the endurance test). If the voltage is equal to or lower than the reference voltage, the end of the lifetime is determined and the power supply is shut off. As a result, the voltage is properly kept from increasing at the end of the lifetime, and the safe and highly reliable lighting device for a display device can be provided.

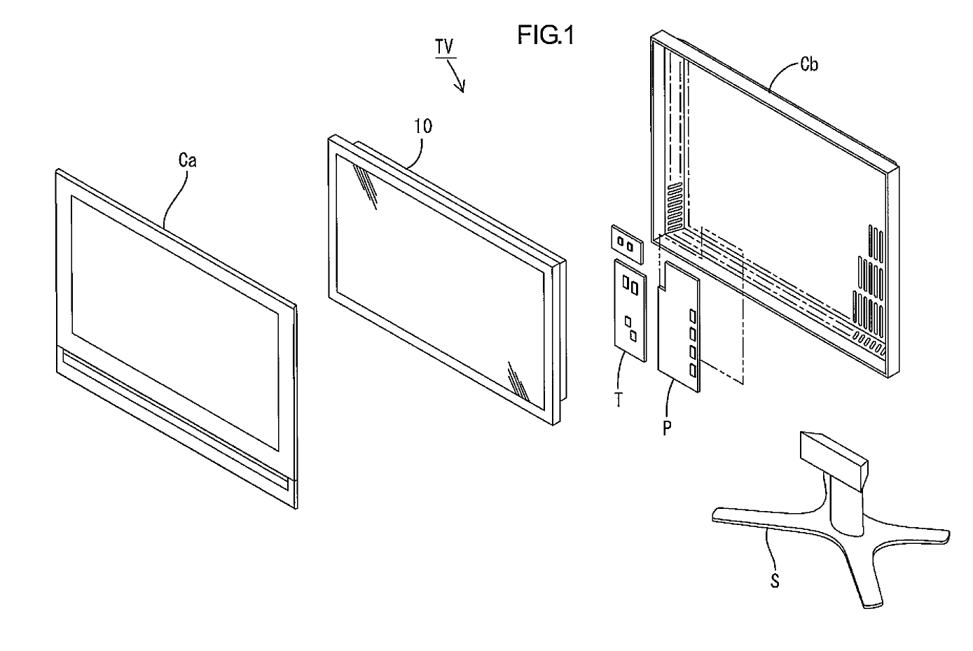

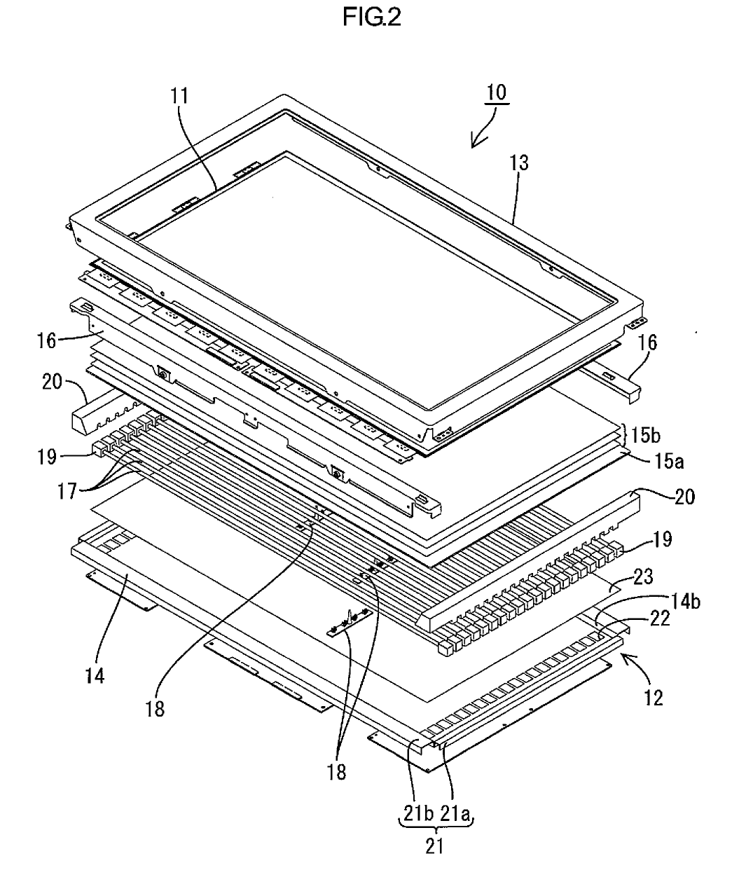

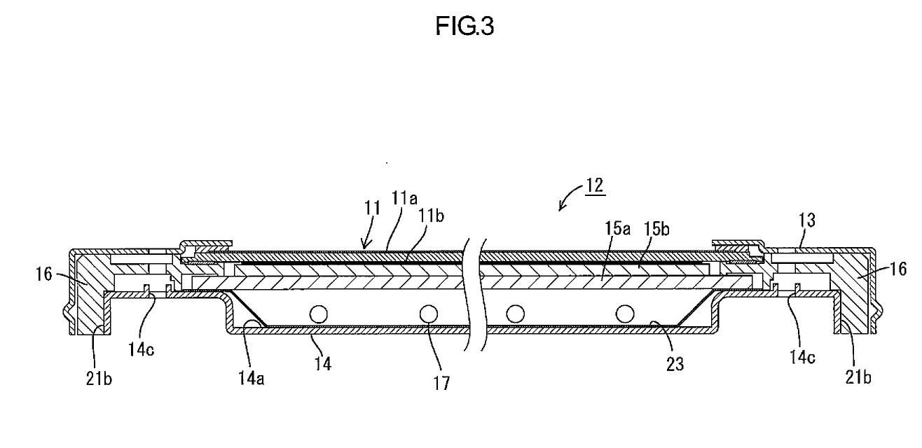

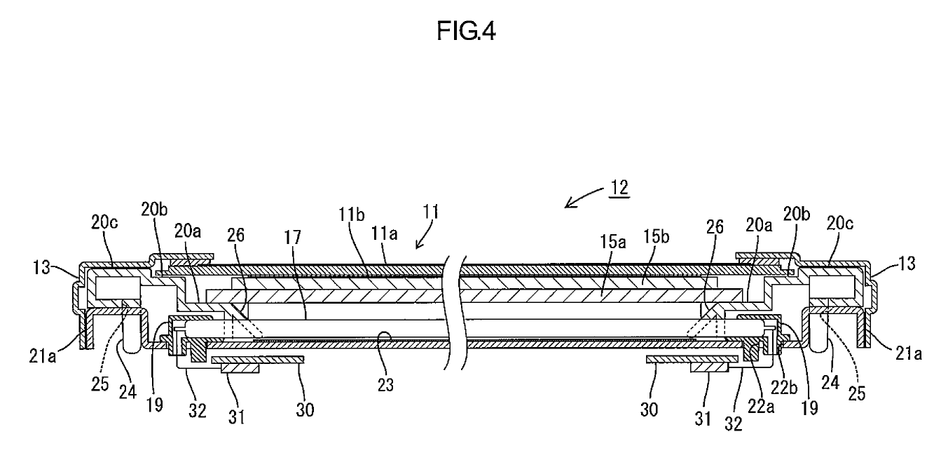

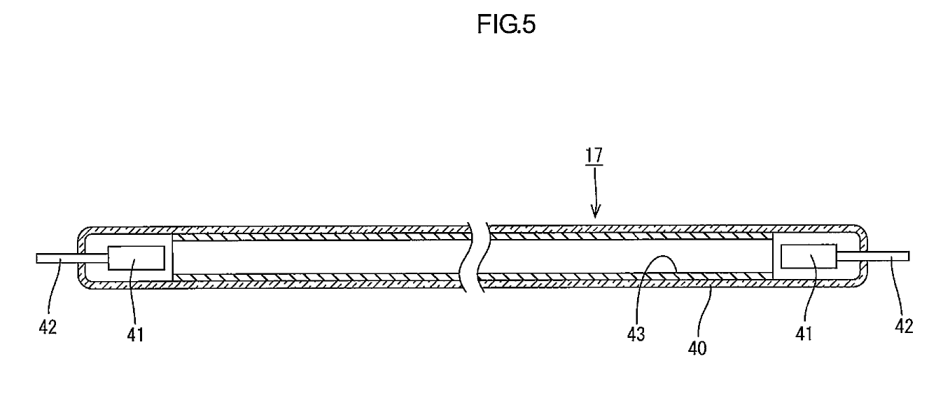

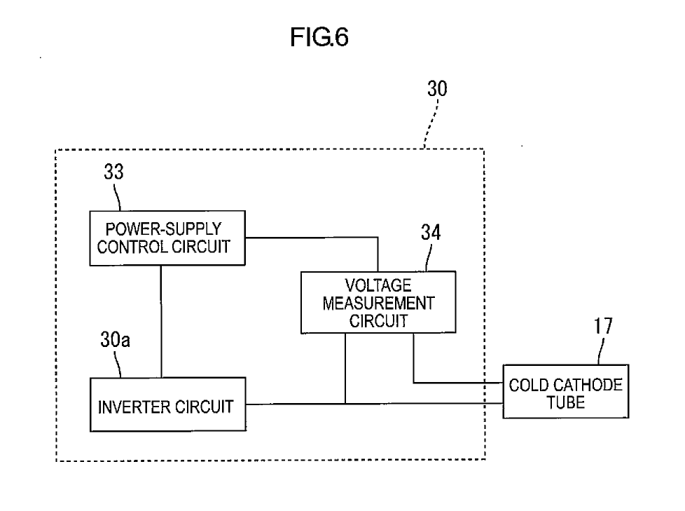

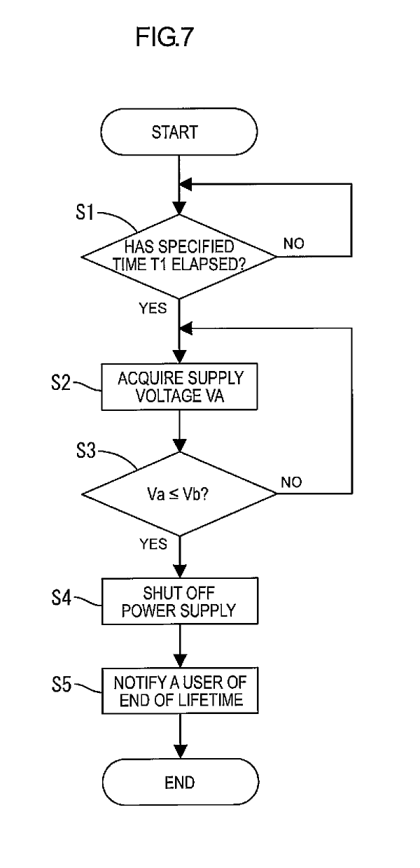

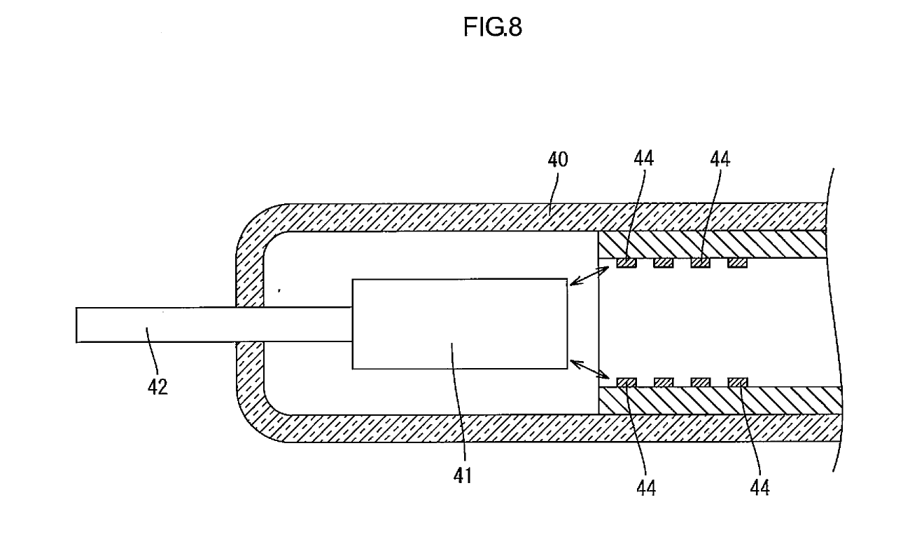

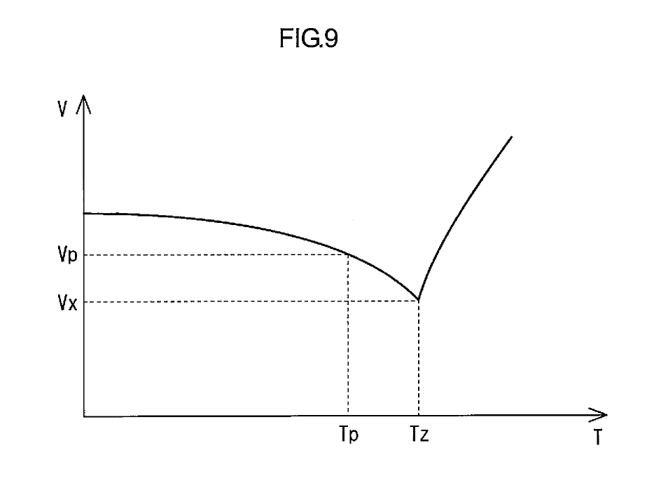

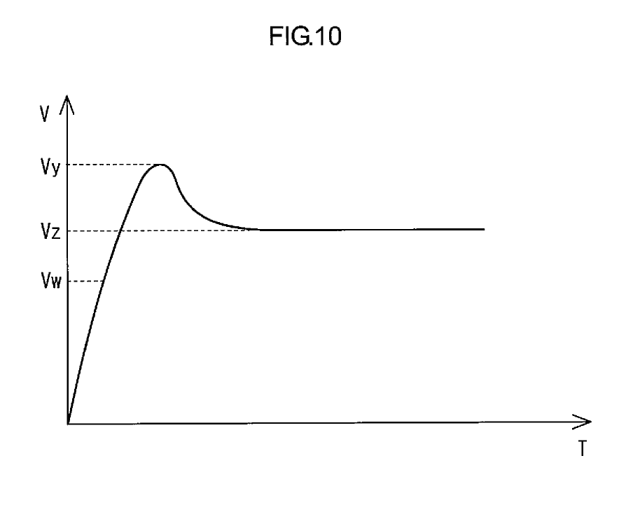

### BRIEF DESCRIPTION OF THE DRAWINGS

[FIG. 1] is an exploded perspective view illustrating a general construction of a television receiver according to the first embodiment of the present invention;

[FIG. 2] is an exploded perspective view illustrating a general construction of a liquid crystal display device included in the television receiver;

[FIG. 3] is a cross-sectional view of the liquid crystal display device along the short-side direction;

[FIG. 4] is a cross-sectional view of the liquid crystal display device along the long-side direction;

[FIG. 5] is a cross-sectional view illustrating a configuration of a cold cathode tube included in the liquid crystal display device;

[FIG. 6] is a block diagram illustrating a configuration of a power supply control in a backlight unit;

[FIG. 7] is a flowchart of the power supply control in the backlight unit;

[FIG. 8] is a view illustrating a cold cathode tube at an end of its lifetime;

[FIG. 9] is a chart illustrating a relationship between voltage and time in an endurance test of the cold cathode tube; and

[FIG. 10] is a chart illustrating variations in voltage at time shortly after the cold cathode tube is turned on.

### BEST MODE FOR CARRYING OUT THE INVENTION

An embodiment of the present invention will be explained with reference to drawings.

FIG. 1 is an exploded perspective view illustrating a general construction of a television receiver. FIG. 2 is an exploded perspective view illustrating a general construction of a liquid crystal display device included in the television receiver in FIG. 1. FIG. 3 is a cross-sectional view of the liquid crystal display device in FIG. 2 along the short-side direction. FIG. 4 is a cross-sectional view of the liquid crystal display device in FIG. 2 along the long-side direction.

As illustrated in FIG. 1, the television receiver TV of this embodiment includes the liquid crystal display device 10, a front cabinet Ca, a rear cabinet Cb, a power source P, a tuner T and a stand S. The liquid crystal display device 10 is held between the front cabinet Ca and the rear cabinet Cb. The liquid crystal display device (a display device) 10 has a landscape rectangular overall shape. The liquid crystal display device 10 is held in a vertical position and housed. As illustrated in FIG. 2, the liquid crystal display device 10 includes a liquid crystal panel 11, which is a display panel, and a backlight unit (a lighting device) 12, which is an external light source. The liquid crystal panel 11 and the backlight unit 12 are held together by a frame-shaped bezel 13.

Next, the liquid crystal panel 11 and the backlight unit 12 included in the liquid crystal display device 10 will be explained (see FIGS. 2 to 4).

The liquid crystal panel (a display panel) 11 includes a pair of transparent glass substrates bonded together with a predetermined gap therebetween and liquid crystals sealed between the substrates. On one of the glass substrates, switching components (e.g., TFTs), pixel electrodes and an alignment film are arranged. The switching components are connected to gate lines and the source lines that are perpendicular to each other. The pixel electrodes are connected to the switching components. On the other glass substrate, color filters including R (red) G (green) B (blue) color sections in predetermined arrangement, a counter electrode and an alignment film are arranged. Polarizing plates 11a and 11b are arranged on outer surfaces of the glass substrates, respectively (see FIGS. 3 and 4).

As illustrated in FIG. 2, the backlight unit 12 includes a chassis 14, a diffuser 15a, an optical sheet 15b and frames 16. The chassis 14 has a box-like overall shape and an opening 14b on the light-exiting surface side (the liquid crystal panel 11 side). The diffuser 15a is arranged so as to cover the opening 14b of the chassis 14. The optical sheet 15b is arranged between the diffuser 15a and the liquid crystal panel 11. The frames 16 are arranged along the long sides of the chassis 14 and hold the long edges of the diffuser 15a to the chassis 14. Furthermore, cold cathode tubes 17, lamp clips 18, lamp connectors 19 and holders 20 are arranged inside the chassis 14. The lamp clips 18 hold the cold cathode tubes 17 at a specified height inside the chassis 14. The cold cathode tubes 17 are mounted to the chassis 14 via the lamp connectors 19 that hold respective ends of the respective cold cathode tubes 17. The holders 20 collectively cover the ends of the cold cathode tubes 17 and the lamp connectors 19. In the backlight unit 12, a side closer to the diffuser 15a than the cold cathode tubes 17 is a light output side.

The chassis 14 is formed in a substantially shallow box shape by processing a metal plate. It includes a rectangular bottom plate 14a and outer rim portions 21 (short-side outer rim portions 21a and long-side outer rim portions 21b), each of which extends upright from the corresponding side of the bottom plate 14a and has a substantially U shape. As illustrated in FIG. 4, the bottom plate 14a has a plurality of through holes including stopper holes 22a and insertion holes 22b, near the ends of long sides thereof. These holes are provided for mounting the lamp connectors 19. As illustrated in FIG. 3, fixing holes 14c, which are through holes, are provided in the upper surface of the chassis 14 along the long-side outer rims 21b to bind the bezel 13, the frames 16 and the chassis 14 together with screws and the like.

A reflection sheet 23 is disposed on an inner surface of the bottom plate 14a of the chassis 14 (on a side that faces the cold cathode tubes 17). The reflection sheet 23 is a synthetic resin sheet having a surface in white that provides high light reflectivity. It is placed so as to cover almost entire inner surface of the bottom plate 14a of the chassis 14. As illustrated in FIG. 3, long-side edges of the reflection sheet 23 are lifted so as to cover the long-side outer rims 21b of the chassis 14 and sandwiched between the chassis 14 and the diffuser 15a. With this reflection sheet 23, light emitted from the cold cathode tubes 17 is reflected toward the diffuser plate 15a.

As illustrated in FIG. 4, the inverter board 30 is mounted to the outer surface of the bottom plate 14a of the chassis 14 (on a side opposite from the surface to which the cold cathode tubes 17 are mounted). The inverter board set 30 is provided for supplying power to the cold cathode tubes 17. The inverter board 30 includes a circuit (not shown) for generating power to be supplied to the cold cathode tubes 17. Board connectors 31 connected to the circuit are mounted on the inverter board 30 near the outer edges (the ends of the long sides of the chassis 14). Harnesses for transmitting driving power extend from the board connectors 31. When the harnesses are connected to the cold cathode tubes 17, power can be supplied to the cold cathode tubes 17.

On the opening 14b side of the chassis 14, the diffuser 15a and the optical sheets 15b are provided. The diffuser 15a includes a synthetic resin plate containing scattered light diffusing particles. It diffuses linear light emitted from the cold cathode tubes 17 that are tubular lamps. As illustrated in FIG. 4, the short-side edges of the diffuser 15a are placed on the first surface 20a of the holders 20. The short-side edges do not receive a vertical force. As illustrated in FIG. 3, the long-side edges of the diffuser plate 15a are sandwiched between the chassis 14 (or the reflecting sheet 23) and the frame 16, and fixed.

The optical sheet 15b arranged on the diffuser 15a includes a diffuser sheet, a lens sheet and a reflecting type polarizing sheet layered in this order from the diffuser plate 15a side. Light emitted from the cold cathode tubes 17 passes through the diffuser 15a and enters the optical sheet 15b. The optical sheet 15b convert the light to planar light. The liquid crystal display panel 11 is disposed on the top surface of the top layer of the optical sheet 15b. The optical sheet 15b is held between the diffuser 15a and the liquid crystal panel 11.

Each cold cathode tube 17 has an elongated tubular shape. A plurality of the cold cathode tubes 17 are installed in the chassis 14. The cold cathode tubes 17 are arranged parallel to each other with the long-side direction thereof (the axial direction) aligned along the long-side direction of the chassis 14 (see FIGS. 2 and 4). As illustrated in FIG. 5, each cold cathode tube 17 includes a glass tube 40, electrodes 41 and outer leads 42. The glass tube 40 is formed in an elongated shape and ends thereof are closed. The electrodes 41 are arranged at the ends of the glass tube 40 and sealed inside the glass tube 40. The outer leads 42 project from the electrodes 41 and penetrate through the glass tube 40. Noble gas and mercury are sealed in the glass tube 40. Fluorescent substances 43 are applied to an inner wall of the glass tube 40. End parts of each cold cathode tube 17 in which the electrodes 41 are arranged are non-luminescent portions and the middle part (in which the fluorescent substances 43 are applied) is a luminescent portion. The cold cathode tube 17 is held with the lamp clips 18 so as to be away from the bottom plate 14a of the chassis 14 (or the reflection sheet 23) with a small gap. The ends of the cold cathode tubes 17 are attached to the respective lamp connectors 19. The holders 20 are mounted so as to cover the lamp connectors 19.

In this embodiment, sizes of the cold cathode tubes 17 and their arrangements are defined as follows. The diameter of each cold cathode tube 17 used in this embodiment is 4.0 mm. The distance between the cold cathode tubes 17 and the reflection sheet 23 is 0.8 mm. The distance between the adjacent cold cathode tubes 17 is 16.4 mm. The distance between the cold cathode tubes 17 and the diffuser plate 15a is 2.7 mm. In this backlight device 12, distances between the components are defined so as to reduce the thickness of the backlight device 12. Especially, the distance between the cold cathode tubes 17 and the diffuser 15a and the distance between the cold cathode tubes 17 and the reflection sheet 23 are reduced. Because of the thickness reduction of the lighting device 12, the liquid crystal display device 10 and that of the television receiver TV are provided with the following thicknesses. The thickness of the liquid crystal display device 10 (i.e., the thickness between the front surface of the liquid crystal panel 11 and the back surface of the backlight device 12) is 16 mm. The thickness of the television receiver TV (i.e., the thickness between the front surface of the front cabinet Ca and the back surface of the rear cabinet Cb) is 34 mm. Namely, a thin television receiver is provided.

The holders 20 that cover the ends of the cold cathode tubes 17 are made of white synthetic resin. As illustrated in FIG. 2, each of them has an elongated substantially box shape that extends along the short side of the chassis 14. As illustrated in FIG. 4, each holder 20 has steps on the front side such that the diffuser 15a and the liquid crystal panel 11 are held at different levels. A part of the holder 20 is placed on top of apart of the corresponding short-side outer rim 21a of the chassis 14 and forms a side wall of the backlight device 12 together with the short-side outer rim 21a. An insertion pin 24 projects from a surface of the holder 20 that faces the outer rim 21a of the chassis 14. The holder 20 is mounted to the chassis 14 by inserting the insertion pin 24 into the insertion hole 25 provided in the top surface of the short-side outer rim 21a of the chassis 14. The steps of the holder 20 include three surfaces parallel to the bottom plate 14a of the chassis 14. The short edge of the diffuser plate 15a is placed on the first surface 20a located at the lowest level. A sloped cover 26 extends from the first surface 20a toward the bottom plate 14a of the chassis 14. A short edge of the liquid crystal panel 11 is placed on the second surface 20b. The third surface 20c located at the highest level is provided such that it overlaps the short-side outer rim 21a of the chassis 14 and comes in contact with the bezel 13.

As illustrated in FIG. 6, the inverter board 30 includes an inverter circuit 30a, a voltage measurement circuit 34 and power-supply control circuit 33. The inverter circuit 30a supplies power to the cold cathode tubes 17. The voltage measurement circuit 34 measures voltages applied to the cold cathode tubes 17. The power-supply control circuit 33 controls power supply to the cold cathode tubes 17 based on the voltage measurement by the voltage measurement circuit 34.

The inverter circuit 30a is a circuit configured to generate high-frequency voltages for turning on the cold cathode tubes 17. The voltage measurement circuit 34 is provided for measurement of a peak voltage across each cold cathode tube 17 with high-voltage probes. The power-supply control circuit 33 is configured to output a power shutoff signal to the inverter circuit 30a if a voltage Va measured by the voltage measurement circuit 34 is equal to or lower than a reference voltage Vb. With this signal, control for shutting off the power supply to the cold cathode tube 17 (i.e., power-supply control) is performed.

FIG. 7 is a flowchart of the power-supply control performed by the power-supply control circuit 33.

As illustrated, whether or not a predefined time T1 has elapsed is determined first (S1). After the television receiver TV is turned on, power supply to the cold cathode tubes 17 starts. A certain time is required until the cold cathode tubes 17 are in stable lighting conditions (condition that variations in voltages per unit time become small). The time is set to wait until the cold cathode tubes 17 are in the stable lighting conditions. If the electrode-supply control starts before the cold cathode tubes 17 become stable, the voltages applied to the cold cathode tubes 17 may be determined equal to or lower than the reference voltage Vb depending on voltages when they are turned on (e.g., low voltages Vw measure shortly after the start of power supply) as illustrated in FIG. 10. In this case, ends of lifetime of the cold cathode tubes 17 may be erroneously determined. It takes a certain period of time the voltage decreases to a stable voltage Vz from a high voltage Vy to which the voltage increases immediately after the start of lighting.

In this embodiment, time required until a variation in voltage becomes significantly small is determined in advance based on a test. The time is determined as the predefined time T1. More specifically, the time to when the voltage variation per unit time (one minute in this embodiment) becomes equal to or lower than 2% of a standard voltage V₀ of the cold cathode tube 17 is determined as the predefined time T1. If the liquid crystal panel 11 has a diagonal dimension of 32 inches, the standard voltage V₀ is 920 Vrms. The time to when the voltage variation is 2% of 920 Vrms, that is, 18.4 V or lower (e.g., 50 to 70 minutes) is determined as the predefined time T1. If the liquid crystal panel 11 has a diagonal dimension of 52 inches, the standard voltage V₀ is 1380 Vrms. The time to when the voltage variation is 2% of 1380 Vrms, that is, 27.6 V or lower (e.g., 40 to 60 minutes) is determined as the predefined time T1.

If the power-supply control circuit 33 determines that the predefined time T1 has elapsed in S1 in FIG. 7, it proceeds to S2. In S2, it acquires the supply voltage Va that is applied to each cold cathode tube 17 from the voltage measurement circuit 34. In S3, the power-supply control circuit 33 determines whether the acquired voltage Va is equal to or lower than the reference voltage Vb. If the acquired voltage Va is higher than the reference voltage Vb, steps S2 and S3 are repeated. Namely, the acquisition of the voltage Va and the comparison between the acquired voltage Va and the reference voltage Vb are repeated. If the voltage Va is equal to or lower than the reference voltage Vb, the power-supply control circuit 33 determines that the cold cathode tube 17 is at an end of its lifetime. It sends a signal for shutting off the power supply to the inverter circuit 30a in S4, and generates an alarm (e.g., an audio alarm output from speakers of the television receive TV) for notifying a user of the end of lifetime in S5.

In this embodiment, the voltage Va applied to each cold cathode tube 17 is measured and determined if it is equal to or lower than the reference voltage Vb. Whether or not the cold cathode tube 17 is at an end of its lifetime is determined based on the above determination. Therefore, the power supply can be shut off before the voltage starts increasing at time close to an end of lifetime of the cold cathode tube 17. As illustrated in FIG. 9, an internal gas pressure of the glass tube 40 of each cold cathode tube 17 decreases as the cold cathode tube 17 is used (i.e., over time), and the applied voltage also decreases. As illustrated in FIG. 8, sputtered materials 44 are gradually deposited on the inner wall of the glass tube 40 near the electrodes 41 and areas of the sputtered materials 44 increase. Electrons flow into the sputtered materials 44 and discharges occur between each electrode and the sputtered materials 44 (as indicated with arrows). When the cold cathode tube 17 comes to the end of its lifetime, the glass tube 40 starts melting due to heat and a hole is formed. As a result, the glass tube 40 loses airtightness and the voltage sharply increases (see FIG. 9).

Namely, the voltage across each cold cathode tube 17 decreases as the cold cathode tube 17 is used. However, the voltage sharply increases when the cold cathode tube 17 comes to an end of its lifetime Tz. A voltage Vx shortly before the end of the lifetime is determined in advance based on a result of an endurance test and determined as the reference voltage Vb (can be set a few % higher than Vx). If the voltage is equal to or lower than the reference voltage Vb, the end of the lifetime is determined and the power supply is shut off. As a result, the voltage is properly kept from increasing at time close to the end of the lifetime. In the endurance test, the voltage is plotted versus time to create a V-T chart. The lowest voltage is determined as the voltage Vx.

In this embodiment, the reference voltage Vb is set equal to or lower than the voltage Vp that measures after a voltage is applied to the cold cathode tube for a lifetime Tp of the liquid crystal panel 11 (a specified value: 100,000 hours in this embodiment). As a result, the power supply to the cold cathode tube 17 is less likely to be shut off before the liquid crystal panel 11 comes to the end of its lifetime.

In this embodiment, the reference voltage Vb is set in a range expressed by Vx≦Vb≦Vp.

As described above, the voltage Va applied to each cold cathode tube 17 is measured and the power supply to the cold cathode tube is shut off if the voltage Va is equal to or lower than the reference voltage Vb. Therefore, the power supply to the cold cathode tube 17 can be shut off before the voltage starts increasing at time close to the end of lifetime of the cold cathode tube 17. In the backlight 12 of the television receiver TV, fire hazards and electrical shock hazards caused by touching parts during troubleshooting are less likely to be created due to the discharge at time close to the end of lifetime of the cold cathode tubes 17. Therefore, the safe and highly reliable television receiver can be provided.

The reference voltage Vb is set equal to or higher than the voltage Vx that is applied to the cold cathode tube 17 shortly before the end of the lifetime determined based on the result of the endurance test of the cold cathode tube 17. Therefore, the power supply to the cold cathode tube 17 is properly shut off. The reference voltage Vb is set equal to or lower than the voltage Vp that measures after the voltage is applied to the cold cathode tube 17 for the lifetime Tp of the liquid crystal panel 11. Therefore, the power supply to the cold cathode tube 17 is less likely to be shut off before the liquid crystal panel comes to the end of its lifetime.

The power-supply control circuit 34 starts the power-supply control when the cold cathode tubes 17 are in the stable lighting conditions after they are turned on. The voltage may be determined equal to or lower than the reference voltage Vb because of the voltage Vw that measures shortly after the start of the power supply to the cold cathode tubes 17. With the above configuration, the end of lifetime of the cold cathode tube 17 is less likely to be erroneously determined based on the above determination.

The present invention is not limited to the above embodiment explained with reference to the drawings. For example, the following embodiments are included in the scope of the present invention. In the above embodiment, the reference voltage Vb is set in the range expressed by Vx≦Vb≦Vp. However, it may be set in a range expressed by Vx≦Vb≦0.95V₀, where V₀ is a standard voltage of the cold cathode tube 17. By setting the voltage Vb in that range, the power supply to the cold cathode tube 17 is less likely to be shut off within the error range of the supply voltage. An error in the supply voltage is within ±5% of the standard voltage V₀. By setting the reference voltage Vb equal to or lower 0.95V₀, which is lower than the error range, the power supply is less likely to be shut off within the error range.

If the liquid crystal panel 11 has a diagonal dimension of 32 inches, the standard voltage V₀ is 920 Vrms and 5% thereof is the error range (874 to 966). In this case, the reference voltage Vb is set equal to or lower than 874 Vrms. If the liquid crystal panel 11 has a diagonal dimension of 52 inches, the standard voltage V₀ is 1380 Vrms and 5% thereof is the error range (1311 to 1449). In this case, the reference voltage Vb is set equal to or lower than 1311 Vrms.

1. A lighting device for a display device configure to illuminate a display panel, comprising:
a cold cathode tube:
an inverter circuit configured to supply power to the cold cathode tube:
a voltage measurement circuit configured to measure a voltage of power supplied to the cold cathode tube: and
a power-supply control circuit configured to perform power-supply control for shutting off power supply to the cold cathode tube according to the voltage measuring equal to or lower than a reference voltage, the voltage being measured by the voltage measurement circuit.

2. The lighting device for a display device according to claim 1, wherein the reference voltage is equal to or higher than a voltage applied to the cold cathode tube at time shortly before an end of lifetime of the cold cathode tube in an endurance test of the cold cathode tube.

3. The lighting device for a display device according to claim 1, wherein the reference voltage is equal to or lower than a voltage measuring after being applied to the cold cathode tube for lifetime of the display panel.

4. The lighting device for a display device according to claim 1, wherein the reference voltage is equal to or lower than 0.95V0, where V0 is a standard voltage of the cold cathode tube.

5. The lighting device for a display device according to claim 1, wherein the power-supply control circuit starts the power-supply control according to determination of a stable lighting condition of the cold cathode tube.

6. The lighting device for a display device according to claim 1, wherein the cold cathode tube has characteristics to be in the stable lighting condition after a predefined time elapses from a start of the power supply to the cold cathode tube.

7. The lighting device for a display device according to claim 5, wherein the cold cathode tube has characteristics to be in the stable lighting condition that is determined according to a negative variation in voltage per minute, the voltage being applied to the cold cathode tube.

8. A display device comprising:
the lighting device for a display device according to claim 1; and
a display panel configured to provide display using light from the lighting device for a display device.

9. The display device according to claim 8, wherein the display panel is a liquid crystal panel including liquid crystals.

10. A television receiver comprising the display device according to claim 8.
